(19) United States
(12) Patent Application Publication
(10) Pub. No.: US 2012/0228891 A1
(43) Pub. Date: Sep. 13, 2012

(54) Apparatus and Method for Docking a Boat

(76) Inventors: Sara Howard, Roxbury, CT (US); Richard W. Howard, JR., Roxbury, CT (US)

(21) Appl. No.: 13/508,847

(22) PCT Filed: Nov. 10, 2010
(86) PCT No.: PCT/US10/56134

§ 371 Date: May 9, 2012

Related U.S. Application Data
(60) Provisional application No. 61/280,868, filed on Nov. 10, 2009.

(51) Int. Cl. B63B 21/00; B63B 21/54; A01K 74/00

(52) U.S. Cl. 294/191; 114/221 R

(57) ABSTRACT

A mooring tube with a rope slidingly held within the bore of the tube and configured to form an adjustable circumference capture loop held at one end of the tube and being capable of engaging and tightening around a mooring post or deck cleat by a person on a boat for aid in docking and mooring the boat is presented. In some embodiments the tube has an adjustable length to hold the capture loop extended a distance from the end of the tube. In some embodiments boating accessory implements may be attached to the end of the mooring tube.

### CROSS REFERENCE TO RELATED APPLICATION

Reference is made to and priority is claimed from U.S. Provisional Application Ser. No. 61/280,868 filed Nov. 10, 2009 the disclosure and contents of which are incorporated herein by reference.

### FIELD OF THE INVENTION

The present invention relates generally to apparatus and methods for docking a boat and snaring large fish and deals more particularly with a multi-purpose mooring tube system.

### BACKGROUND OF THE INVENTION

The process of docking or mooring a boat generally requires that a docking or mooring line be thrown from the boat to dock personnel on the dock to secure the end of the line to a mooring piling or dock cleat while a crew member or person on the boat pulls on the opposite end to shorten the distance of the line between the boat and the dock as the boat driver guides the boat toward the dock. The end of the docking line on the boat is tied to a boat cleat to secure the boat to the dock once the boat is maneuvered into a desired position alongside the dock. In instances where there are no dock personnel present on the dock as is typical in marinas berthing smaller boats, for example 12 feet to 200 feet in length, a person on the boat would throw the docking line onto the dock and then jump from the boat onto the dock as the boat driver guides the boat toward the dock to secure the end of the docking line to a mooring piling or dock cleat, the opposite end of the docking line being tied to a boat cleat. The person on the dock would shorten the line to secure the boat to the dock as the boat driver maneuvered the boat into a desired position alongside the dock.

Another common method used in docking or mooring a boat is to form a loop in the end of the docking line and then throwing the looped end of the docking line toward the intended mooring target for example a mooring piling or a dock cleat. In many instances, a crew member or person on the boat positions himself/herself close to the bow of the boat and then either reaches stretching beyond the side of the boat to drape the loop over the mooring target, or attempts to throw the loop over the mooring target. Reaching beyond the side of the boat can be both dangerous and uncomfortable, and the throwing of the loop requires skill in throwing ropes and capturing the mooring target, both of which may take considerable time and be frustrating and more often than not results in failure since the mooring target is missed, particularly when the boat is moving.

Pole-like devices have been proposed which attempt to permit a crew member or person to reach out with the mooring line toward the intended mooring target however these devices are generally not satisfactory and have various short comings and are difficult to use.

U.S. Pat. No. 4,667,617—In this patent the rope which forms the loop to be placed over a boat cleat/piling is held on by two hooks such that the rope can fall off of the two hooks in the water if the boat hook is not held carefully in the correct position.

U.S. Pat. No. 5,699,748—In this patent the mooring line which is used to put around the piling/cleat is located on the outside of the U-shaped device, and the U-shape is also large making it more difficult to store on a boat.

U.S. Pat. No. 3,945,335—In this patent the loop which is put over a piling/cleat is not held open by a solid piece of material. The loop may not stay open in a uniform shape and size, making it difficult to get over a piling/cleat.

U.S. Pat. No. 6,928,945—In this patent the flexible portion that goes around the piling/cleat is not made of a mooring line, therefore when the boat is to be tied to the dock the user has to switch to a mooring line to tie to the dock.

U.S. Pat. No. 4,261,280—In this patent the mooring line is located on the outside of the tubing, therefore once the loop is put over the piling/cleat the tube must be detached and then the user must tighten the mooring line on the piling/cleat by hand.

U.S. Pat. No. 3,993,013—In this patent the loop that is put around the cleat/mooring is made of plastic, which loop cannot be tied to the boat or the dock.

U.S. Pat. No. 3,918,385—In this patent the mooring line is located on the outside of the device and the user must buy a boat stick in order to use the device.

U.S. Pat. No. 4,635,986—In this patent the mooring line is located on the outside of the device and loop that is put around piling/cleat is held on by hooks, therefore the mooring line could slip off prior to reaching the intended piling/cleat.

The DockMate® does not have a mooring line attached to the end of the loop, therefore once the user hooks onto a piling/cleat the user must also unhook the DockMate® enabling a mooring line to be placed around the piling/cleat, during this time the boat can move significantly and no longer be close to the dock.

What is needed therefore is an apparatus for docking and securing a boat that overcomes the short comings and disadvantages of known devices.

### DISCLOSURE OF THE INVENTION

In a first broad aspect of the invention, a mooring tube system comprises a single tube or a multiple tube section variable length rigid and/or slightly flexible tube slightly larger in diameter than a mooring line used to secure a boat to a dock. The mooring tube is designed to function with most flexible standard mooring lines. The mooring tube system allows an on board deckhand to secure the mooring line to the dock or piling without having to leave the boat. The mooring tube length is fixed or variable to accommodate different size boats and distances from the mooring post or dock cleat. The mooring tube is an inexpensive, simple to use, easily constructed, and safe solution to aid in docking small to medium size (12 feet to 200 feet) boats without help from on dock personnel.

In another broad aspect of the invention the mooring tube has two holes located at the opposite end of the handle that can be used to insert various boating tools when not used for docking. An acme screw attachment may also be inserted into the two holes; this furthers the options for what components may be purchased and attached to the mooring tube. Such components/tools may include a mop, scrub brush, squeegee and similar attachments. If the optional attachments are to be used, the mooring line is removed from the mooring tube and the optional attachments are connected to the end of the mooring tube.

The present invention solves at least one problem of other dock assisting devices because the size of the capture loop which is used to put around a piling/cleat is adjustable. If the boat is docking next to a piling (larger & taller than cleat) the circumference of the capture loop can be made larger so it is able to go overtop a piling and can be made smaller to secure to a cleat which is smaller & lower to water. The mooring tube has an adjustable length. If the boat is unable to get close to the dock, the mooring tube can be lengthened reach down toward a cleat or up to a piling. The adjustable length mooring tube may be decreased in length to become compact in size, making it easy to store on a boat which may have limited storage space.

Another feature of the invention is once the mooring line is around the cleat or piling the user is able to tighten the mooring line around the cleat/piling by moving the end of the mooring tube away from the cleat/piling. This assures that the mooring line is instantly secure around the cleat/piling.

In another broad aspect of the invention the mooring line is inside of the tube and not on the outside such that the capture loop that goes around the cleat/piling does not have a chance of becoming undone or falling into the water prior to docking.

The present invention is not limited for use as a mooring device and may be used for example as a “tailer” for snaring a large fish using the capture loop to encircle and tighten around the tail of the fish to secure the fish and aid the user in bringing the fish onto the boat.

### BRIEF DESCRIPTION OF THE DRAWINGS

The foregoing and other features of the present invention will become readily apparent from the following written description when taken in conjunction with the drawing figures wherein:

FIG. 1 shows a schematic representation of an example of single tube apparatus embodying the present invention.

FIG. 2 shows a schematic representation of an example of a multiple tube apparatus embodying the present invention.

FIGS. 3A-3F show a schematic representation of an example of a releasable clamping mechanism for holding the tube sections in a fixed relation to one another to provide for an adjustable length apparatus in one example of the invention.

FIGS. 4A-4B show a schematic representation of another example of a multiple tube apparatus embodying the present invention.

### DETAILED DESCRIPTION

According to some embodiments, the present invention provides a way to solve the problem of how to extend a mooring line away from a boat to capture a mooring target without the dangerous act of reaching or stretching over the side of a boat. The problem is solved according to some embodiments of the invention by use of a mooring tube with a rope slidingly held within the bore of the tube and configured to form an adjustable circumference capture loop held at one end of the tube and being capable of engaging and tightening around a mooring post or deck cleat by a person on a boat for aid in docking and mooring the boat. In the following written description, like reference numbers refer to like parts.

FIG. 1 shows a schematic representation of an example of single tube mooring apparatus embodying the present invention and is generally designated 10 and comprises in some embodiments an axially elongated tube 12 having a first end 14 and a second end 16 opposite the first end 14 and a suitable length L chosen to carry out the intended purpose of the invention. An axial bore 18 extends through the tube 12 and has a diameter that is slightly larger than the outer diameter 20 of a flexible rope 22 of indeterminate length having a first end 21 and a second end 23 such that the rope 22 may slidingly move within the bore 18 in a back and forth direction as indicated by the movement arrow 24. The rope 22 is longer than the length of the tube 12 and a first section 26 of the rope 22 extends out of the first end 14 of the tube. A second section 28 of the rope 22 extends out of the second end 16 of the tube. The second end 23 of the rope 22 is configured to have a loop 30 and is sized to slip over the outer diameter of the tube 12 to define a capture loop generally designated 32 formed between the tube 12 and the section 28 of the rope 22 extending out of the second end 16 of the tube. The capture loop 32 is thus positioned an extended distance L1 from the first end 14 of the tube 16. The opening 34 of the capture loop 32 may be made increased or made larger as shown by the dashed line loop 32a by increasing the length of the rope section 28 extending from the second end 16 of the tube 12 or may be decreased or made smaller as shown by the dashed line loop 32b by decreasing the length of the rope section 28 extending from the second end 16 of the tube 12. In some embodiments the tube 12 may have a first grip 36 located at the first end 14 of the tube and a second grip 38 intermediate the first end 14 and second end 16 of the tube 12 and spaced from one another so as to be comfortable to a user of the apparatus 10. The grip may be made of a synthetic material such as a rubber or plastic material.

The flexible rope 22 may be any rope suitable to carry out the intended function of the apparatus embodying the invention. Such rope is commonly known as deck line or mooring line. The inventors have found a commercially available double braid dock line of one-half inch diameter and twenty foot length to be suitable for use with the invention. The flexible rope 22 may have a spliced eye to form the loop 30. It will be understood that other dimension and length flexible rope may be used to carry out the intended function of the invention.

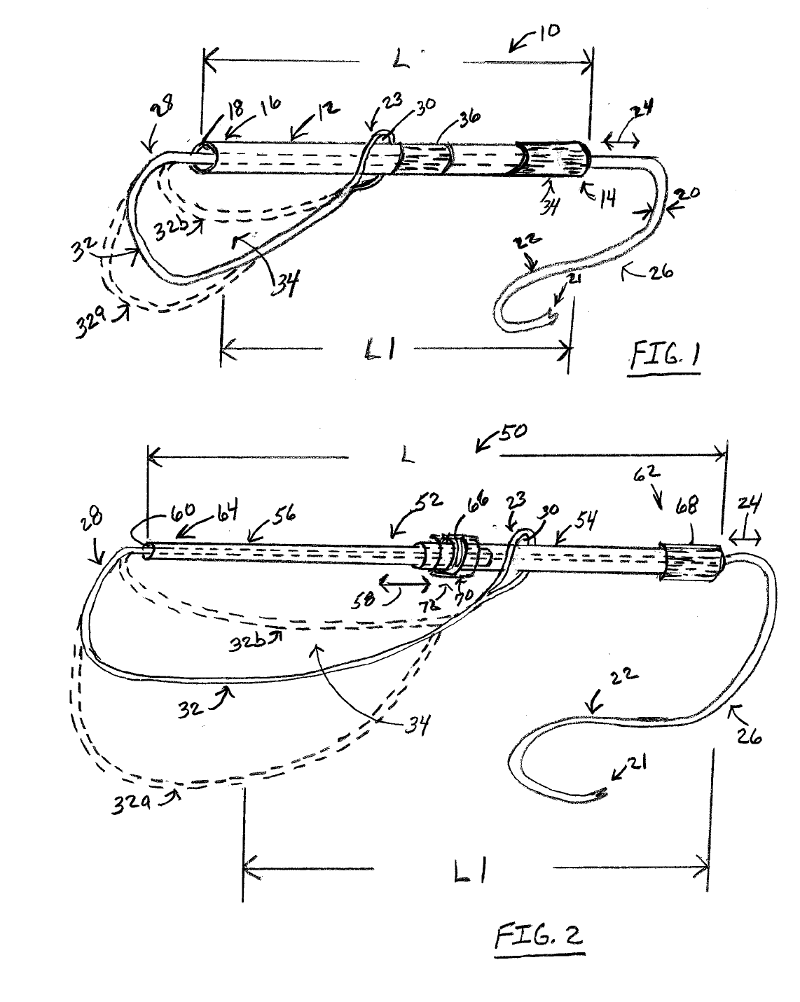

FIG. 2 shows a schematic representation of an example of a multiple tube mooring apparatus embodying the present invention and is generally designed 50 and comprises in some embodiments an axially elongated tube 52 having a first tube section 54 having an axially bore therethrough and a second tube section 56 having an axially bore therethrough. As shown in FIG. 2 the second tube section 56 is arranged to be received in the first tube section 54 and has an outer diameter slightly smaller than the inner diameter of the first tube section 54 and is arranged to move telescopically as shown by the movement arrow 58 with respect to one another to define a variable adjustable length tube. The respective axially elongated bores of the first and second tubes when telescopically arranged also define an axially elongated bore 60 extending between a first end 62 of the tube 52 and an oppositely disposed second end 64 of the tube 52. The first tube section 54 and second tube section 56 are telescopically arranged and held in fixed relation with respect to one another using a releasable clamp mechanism generally designated 66 to provide a desired a suitable length L chosen to carry out the intended purpose of the invention. In some embodiments the length end-to-end of a full extended tube 52 is around 78 inches and in a fully collapsed or closed position for storage is around 48 inches. The length of the tube 52 will be seen to be dependent on the length of the respective tube sections and the extension of the second tube section with respect to the first tube section. The length of the tube 52 is not limited to any specific length and may be selected to achieve a desired length to accommodate an intended function or purpose. In some embodiments a stop is located and positioned inside the first tube section at the first end of the tube 52 to prevent the second tube section from passing through and out of the first tube section when the tube is collapsed or closed.

In a similar manner as discussed in connection with FIG. 1, the axially elongated bore 60 has a diameter that is slightly larger than the outer diameter 20 of a flexible rope 22 of indeterminate length having a first end 21 and a second end 23 such that the rope 22 may slidingly move within the bore 60 in a back and forth direction as indicated by the movement arrow 24. The rope 22 is longer than the length of the tube 52 and a first section 26 of the rope 22 extends out of the first end 14 of the tube. A second section 28 of the rope 22 extends out of the second end 16 of the tube. The second end 23 of the rope 22 is configured to have a loop 30 and is sized to slip over the outer diameter of the tube 52 to define a capture loop generally designated 32 formed between the tube 52 and the section 28 of the rope 22 extending out of the second end 16 of the tube. The capture loop 32 is thus positioned an extended distance LI from the first end 14 of the tube 52. The opening 34 of the capture loop 32 may be made increased or made larger as shown by the dashed line loop 32a by increasing the length of the rope section 28 extending from the second end 16 of the tube 52 or may be decreased or made smaller as shown by the dashed line loop 32b by decreasing the length of the rope section 28 extending from the second end 16 of the tube 52. A user can make additional adjustments to the capture loop opening by sliding the loop 30 along the length of the tube while holding the loop 32. In some embodiments the tube 52 may have a first grip 68 located at the first end 62 of the tube and a second grip 70 intermediate the first end 62 and second end 64 of the tube 52 and spaced from one another so as to be comfortable to a user of the apparatus 50. In some embodiments the second grip 70 is configured to cover the releasable clamp 66.

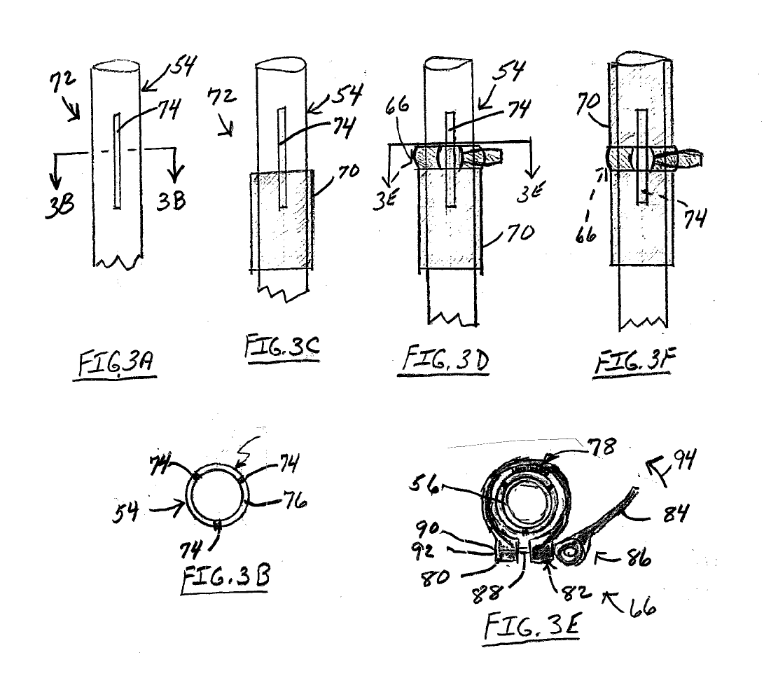

In some embodiments of the invention, the first and second tube sections 54 and 56 respectively are held telescopically in a fixed relation with respect to one another by compressing the end region 72 of the first or outer tube section 54 into contact with the portion of the second tube section 56 inserted into the first tube section 54. One such possible arrangement is shown schematically in FIGS. 3A-3F. In this arrangement slots 74 are cut in the wall 76 of the tube section 54 to allow for ease in compression of the first tube section onto the second tube section. In some embodiments slots are not cut in the wall of the first tube section. In some embodiments, the grip 70 is slid over the tube 54 as shown in FIG. 3C prior to installation of the releasable clamp mechanism 66. FIG. 3D shows schematically the releasable clamp 66 and grip 70 located in position on the tube 54. In some embodiments as shown in FIG. 3E the clamp mechanism 66 is held to the tube section 54 by means of a layer 78 of a suitable adhesive. The clamping mechanism 66 in some embodiments is a “C”-type compression clamp the respective ends 80, 82 of which are oppositely disposed and spaced from one another. A handle or lever 84 is articulated at a cam lobe end 86 to a rod 88 which has a head 90 at one end 92 such when the handle 84 is moved in the direction 94 to its closed operative condition draws the ends 80, 82 toward one another to squeeze the outer tube section 56 against the inner tube section 54. The grip 70 if used may be slid over the clamping mechanism 66 as shown in FIG. 3F.

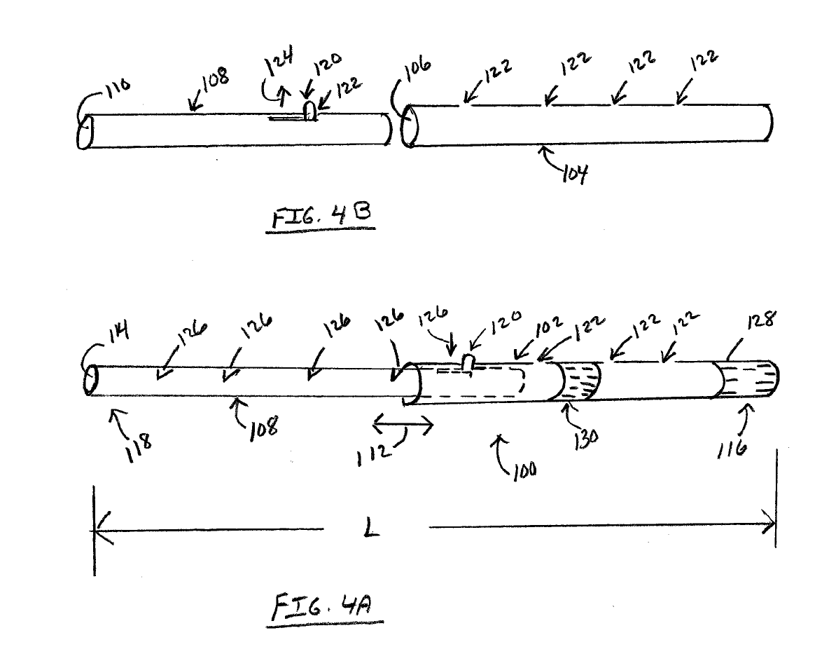

In some embodiments of the invention a schematic representation of a multiple tube mooring apparatus is shown in FIGS. 4A and 4B and generally designated 100. The mooring apparatus 100 and comprises in some embodiments an axially elongated tube 102 having a first tube section 104 having an axially bore 106 therethrough and a second tube section 108 having an axially bore 110 therethrough. As shown in FIGS. 4A and 4B the second tube section 108 is arranged to be received in the first tube section 104 and has an outer diameter slightly smaller than the inner diameter of the first tube section 104 and is arranged to move telescopically as shown by the movement arrow 112 with respect to one another to define a variable adjustable length tube. The respective axially elongated bores 106, 110 of the first and second tubes when telescopically arranged also define an axially elongated bore 114 extending between a first end 116 of the tube 102 and an oppositely disposed second end 118 of the tube 102. The first tube section 104 and second tube section 108 are telescopically arranged and held in fixed relation with respect to one another using a ball-indent releasable clamp mechanism generally designated 120 in cooperation with spaced apart apertures 122 in the wall of the first tube section 104 to provide a desired a suitable length L chosen to carry out the intended purpose of the invention. In some embodiments the length end-to-end of a full extended tube 102 is around 78 inches and in a fully collapsed or closed position for storage is around 48 inches. The length of the tube 102 will be seen to be dependent on the length of the respective tube sections and the extension of the second tube section with respect to the first tube section. The length of the tube 102 is not limited to any specific length and may be selected to achieve a desired length to accommodate an intended function or purpose. In some embodiments a stop is located and positioned inside the first tube section at the first end of the tube 102 to prevent the second tube section from passing through and out of the first tube section when the tube is collapsed or closed. In a similar manner as discussed above in connection with FIGS. 1 and 2, the axial bore 114 has a diameter slightly larger than the outer diameter of the flexible rope (not shown in FIGS. 4A and 4B) to allow the rope to move within the bore 114 of the tube 102. The ball-indent clamp mechanism 120 is spring loaded in an outward direction 124 to maintain the ball-head 122 in an aperture 122. The ball-head 122 is arranged to be pushed in an inward direction 126 to move below the aperture 122 to allow the second tube 108 to move telescopically within the first tube 104 to a desired position to engage with another aperture 122 to adjust the length of the tube 102. The apertures 122 are spaced on the first tube 104 to provide an incrementally adjustable length tube 102. In some embodiments marking indicia 126 are painted or applied on the surface of the second tube 108 and spaced apart corresponding to the spacing of the apertures 122 in the first tube 104 to aid the user in locating the ball-indent head 122 in a desired positioned aperture 122. In some embodiments a grip 128 may be located at or near the first end 116 of the tube 102 and a second grip 130 spaced from the first end 116 at a distance to provide a comfortable holding position to a user.

In some embodiments the first and second tube sections are telescopically held in a fixed relation with respect to one another by means of a releasable twisting locking mechanism such that one tube section is twisted in one direction with respect to the other to tighten the tube sections against one another and twisted in the opposite direction to loosen the tube sections with respect to one another. Twisting locking mechanisms are known to those skilled in the art for example as used in extension poles.

The tube sections may be made from a material such as fiberglass, a plastic such as PVC (polyvinylchloride), polyethelyne, aluminum, stainless steel or other suitable lightweight material to carry out the intended function of the invention.

In some embodiments the flexible rope may not be inserted in the axial bore to allow various interchangeable boating parts such as for example a mop, scrub brush, squeegee to be attached to the end of the axially elongated tube. In some embodiments, the end of the tube may be arranged with one or more apertures to accept and hold a ball-indent shaft having an attachment at one end and to release the attachment. In some embodiments a ball-indent shaft having a screw thread end for threading into an attachment may be used in the end of the tube when the tube is not being used as a mooring device.

The following steps are illustrative of one method for using the mooring tube in some embodiments of the present invention.

1. Sliding the mooring line all the way through the inside of the mooring tube inserting the mooring line through the second end with the optional accessory attachments removed.

2. Sliding the small loop at the second end of the mooring line around the outside of the mooring tube.

3. Adjusting the length of the second portion of the mooring line to form a capture loop.

4. Operating the releasable clamp mechanism.

5. Pulling the second tube section outwards to lengthen the mooring tube to a desired length.

6. Operating the releasable clamp mechanism to hold the first and second tube sections in a fixed position with respect to one another in the desired length.

7. Placing one hand on the grip at one end of the mooring tube and the other hand on the small loop to maintain the small loop in tact to prevent the mooring line from sliding down the mooring tube.

8. Putting the capture loop around the mooring post or cleat when the boat approaches a dock.

9. Releasing the small loop from the hand grasping the small loop, while still holding onto the mooring tube enabling the capture loop to slide down the mooring tube while still holding the mooring tube at the first end and optionally holding the mooring tube with the other hand.

10. Raising and/or moving the end of the mooring tube away from the mooring post or cleat for tightening the capture loop around the mooring post or cleat.

11. Operating the releasable clamping mechanism.

12. Sliding the second tube section into the first tube section to shorten the length of the mooring tube.

13. Sliding the mooring tube away from the mooring line to remove the mooring line from the mooring tube.

14. Using the mooring line to control the boat in response to directions from the boat driver.

It is to be understood that the above-described arrangements are only illustrative of the application of the principles of the present invention and are not to be construed as limitations of the invention. Numerous modifications and alternative arrangements may be devised by those skilled in the art without departing from the scope of the invention and the appended claims are intended to cover such modifications and arrangements. Further, the invention contemplates all embodiments that may be inferred directly or indirectly from the disclosure and drawings whether or not expressly stated and claimed.

1. Apparatus, comprising:
an axially elongated tube having a first end and an oppositely disposed second end, and an axially bore therethrough;
a flexible rope of indeterminate length longer than said axially elongated tube and having a cross-section outer diameter and sized to fit in and slidingly move within said axial bore such that a portion of said rope at one end extends beyond the first end of said tube and a section portion of said rope at a second end opposite the first end of said rope extends beyond the second end of said tube;
said second end of said rope further being configured to slip over and onto said tube to define a loop formed between said tube and said section portion of said rope such that said loop is extended a distance from said first end of said tube;
said loop being capable of having an adjustable circumference for increasing and decreasing the loop opening in response to increasing the portion of said second end of said rope extending from said second end of said tube, and decreasing the portion of said second end of said rope extending from said second end of said tube respectively.

2. The apparatus as defined in claim 1 wherein said axially elongated tube comprises at least two sections arranged telescopically with respect to one another to provide an adjustable length distance between said first and second ends of said tube.

3. The apparatus as defined in claim 2 further comprising a releasable clamp arranged to hold said at least two sections fixed with respect to one another to provide a substantially continuously variable adjustable length in response to one of said at least two tube sections being telescopically moved with respect to one another to achieve a desired tube length.

4. The apparatus as defined in claim 2 further comprising a ball-indent releasable clamp arranged to hold said at least two sections fixed with respect to one another at predefined spaced intervals to provide an incrementally adjustable length in response to one of said at least two tube sections being telescopically moved with respect to one another to achieve a desired tube length.

5. The apparatus as defined in claim 1 wherein said loop is capable of engaging and tightening around a desired target in response to pulling said first end portion of said rope from said first end of said tube.

6. The apparatus as defined in claim 1 wherein said loop is capable of engaging and tightening around a mooring post or deck cleat by a person on a boat for aid in docking and mooring said boat in response to pulling said first end portion of said rope from said first end of said tube.

7. The apparatus as defined in claim 1 wherein said loop is capable of engaging and tightening around a tail of a large fish by a person on a boat for aid in snaring said large fish for removal from water in which said fish is swimming.

8. The apparatus as defined in claim 13 wherein said bore at said second end of said tube is arranged to receive and hold an implement when said rope is not inserted in said bore.

9. The apparatus as defined in claim 8 wherein said implement is arranged to snap into said bore.

10. The apparatus as defined in claim 8 wherein said implement is arranged to screw into and out of said bore.

11. The apparatus as defined in claim 8 wherein said implement is a tool or part for use on a boat.

12. The apparatus as defined in claim 5 wherein said apparatus is configured such that said rope is removable from said axially elongated tube after said loop is tightened around said desired target.

13. The apparatus as defined in claim 1 wherein said apparatus is configured such that said rope is removable from said axially elongated tube when said apparatus is not in use.

14. The apparatus as defined in claim 1 wherein said axially elongated tube further comprises a first grip located in the region at the first end of said axially elongated tube and a second grip in a spaced relation with respect to said first grip and located in the region at the second end of said axially elongated tube.

15. A method for use on a boat comprising
sliding through the inside of an axially elongated tube having a first end and an oppositely disposed second end, and an axially bore therethrough, a flexible rope of indeterminate length longer than said axially elongated tube by inserting the flexible rope through the second end, such that a portion of said rope at one end extends beyond the first end of said tube and a section portion of said rope at a second end opposite the first end of said rope extends beyond the second end of said tube;
sliding a small loop at said second end of said flexible rope around the outside of said tube to define a capture loop formed between said tube and said section portion of said rope such that said capture loop is extended a distance from said first end of said tube;
placing said capture loop around a desired target when the boat approaches said desired target;
enabling said capture loop to slide down said axially elongated tube while still holding said axially elongated tube at the first end;
raising or moving said axially elongated tube away from the desired target for tightening the capture loop around said desired target; and.
sliding said axially elongated tube from said flexible rope to remove said flexible rope from said axially elongated tube.

16. The method as defined in claim 13 wherein said axially elongated tube comprises at least two sections arranged telescopically with respect to one another to provide an adjustable length distance between said first and second ends of said tube, and said method further comprises adjusting the length of said axially elongated tube to a desired length.

17. The method as defined in claim 13 further comprising inserting into said bore at said at said second end of said axially elongated tube an implement for use on a boat and attaching said implement to said axially elongated tube.
